(19) United States
(12) Patent Application Publication
(10) Pub. No.: US 2017/0264904 A1
(43) Pub. Date: Sep. 14, 2017

(54) INTRA-PREDICTION COMPLEXITY REDUCTION USING LIMITED ANGULAR MODES AND REFINEMENT

(71) Applicant: Intel Corporation, Santa Clara, CA (US)

(72) Inventors: Pavel S. KOVAL, Moscow (RU); Nikolai P. SHOSTAK, Moscow (RU); Leonid A. KULAKOV, Moscow (RU); Alexey FADEEV, Nizhny Novrorod (RU)

(21) Appl. No.: 15/501,817

(22) PCT Filed: Sep. 23, 2014
(86) PCT No.: PCT/RU14/00704

§ 371 Date: Feb. 3, 2017

(51) Int. Cl. H04N 19/159; H04N 19/182; H04N 19/50

(52) U.S. Cl. CPC H04N 19/159; H04N 19/50; H04N 19/182

(57) ABSTRACT

Techniques related to selecting intra-prediction angular modes for video encoding are discussed. Such techniques may include evaluating, for a coding unit, encoding costs for only a subset of available intra-prediction angular modes, selecting one or more of the subset as candidate modes based on lowest encoding costs, evaluating encoding costs for neighbors of the selected candidate modes, and providing final candidate modes based on the evaluated encoding costs.

### BACKGROUND

A video encoder compresses video information so that more information can be sent over a given bandwidth or saved in a given file size. The compressed signal or file may be transmitted to a receiver or video decoder that may decode or decompress the signal or file for display to a user. Such video encoder-decoder systems may follow a format or standard. For example, High Efficiency Video Coding (HEVC), jointly developed by the ISO/IEC Moving Picture Expert Group (MPEG) and ITU-T Video Coding Experts Group (VCEG), is one such video compression standard. Similar to previous video coding standards, HEVC includes basic functional modules such as intra/inter prediction, transform, quantization, in-loop filtering, and entropy coding. HEVC defines a Coding Tree Unit (CTU) for a picture that is then partitioned into Coding Units (CUs) that take the form of rectangular blocks having variable sizes. Within each LCU, a quad-tree based splitting scheme specifies the CU partition pattern. HECV also defines Prediction Units (PUs) and Transform Units (TUs) that specify how a given CU is to be partitioned for prediction and transform purposes, respectively. A CU ordinarily includes one luma Coding Block (CB) and two chroma CBs together with associated syntax, and a PU may be further divided into Prediction Blocks (PBs) ranging in size from 64×64 samples down to 4×4 samples. After intra or inter prediction, transform operations are applied to residual blocks to generate coefficients. The coefficients are then quantized, scanned into one-dimensional order and, finally, entropy encoded to generate an HEVC compliant bitstream.

HEVC and other new coding tools introduce intra-prediction techniques that improve compression at the cost of very high computational complexity as compared to previous standards. For example, HEVC encoders may use 35 intra-prediction modes (e.g., a planar mode, a DC mode, and 33 angular modes), which may be specified for each coding unit and/or transform unit (e.g., depending on the HEVC mode). In some HEVC implementations, encoders may perform decisions on intra-prediction modes for a coding units (and transform units) in several stages to reduce computational complexity. For example, at a first stage, all 35 intra-prediction modes may be evaluated and a select number of best modes may be included in a candidate list for subsequent evaluation(s) at increasing levels of precision until a best mode for the coding unit is determined. Also, as discussed, such a coding unit may be split into transform units. At subsequent stages of evaluation, the encoder may evaluate each candidate intra-prediction mode not just at a greater precision, but also for a variety of candidate splits of the coding unit (e.g., a coding unit may be split in many ways and each may be evaluated to determine the final best intra-prediction mode for encoding the coding unit).

Such multi-stage techniques may provide efficiencies, but computational complexity remains high. As such, existing techniques do not provide reduced computational complexity while maintaining compression efficiency. Such problems may become critical as the desire to compress high quality video becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a flow diagram illustrating an example process for providing candidate intra-prediction modes;

FIG. 2 is a diagram illustrating intra-prediction angular modes including example available intra-prediction angular modes;

FIG. 3 is a diagram illustrating intra-prediction angular modes including an example subset of available intra-prediction angular modes;

FIG. 4 is a diagram illustrating intra-prediction angular modes including example selected intra-prediction angular modes;

FIG. 5 is a diagram illustrating intra-prediction angular modes including example selected intra-prediction angular modes and example neighboring intra-prediction angular modes;

FIG. 6 is a diagram illustrating intra-prediction angular modes including example candidate intra-prediction angular modes;

FIG. 7 illustrates a block diagram of an example encoder;

FIG. 8 illustrates a block diagram of an example intra-prediction modes pre-selection module;

FIG. 9 illustrates an example encoded bitstream;

FIG. 10 is a flow diagram illustrating an example process for video encoding;

FIG. 11 is an illustrative diagram of an example system for video encoding;

FIG. 12 is an illustrative diagram of an example system; and

FIG. 13 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to video encoding and, in particular, to selecting intra-prediction modes for encoding.

As described above, current codecs may improve compression at the expense of computational complexity. For example, the High Efficiency Video Coding (HEVC) standard may provide for 35 intra-prediction modes, which may each be evaluated for a coding unit as well as various transform unit splits of the coding unit. A full evaluation of such intra-prediction modes at all available coding unit splits is very computationally intensive. The techniques discussed herein may reduce such computational complexity with negligible decreases in coding efficiency. In some embodiments discussed herein, encoding costs may be determined for only a subset of available intra-prediction modes. In the example of HEVC, the available intra-prediction modes may include a DC (e.g., flat) mode, a planar (e.g., surface fitting) mode, and 33 angular modes. In an embodiment, the subset of intra-prediction modes may include the DC mode, the planar mode, and every N^{th} angular mode (e.g., every other angular mode, every third angular mode, and so on). Based on the encoding costs, a number of best modes (e.g., 3, 4, or 8 modes or the like) may be selected. For selected angular modes, encoding costs may be determined for neighbors of the selected angular modes. In an embodiment, both immediate neighbors of a selected angular mode may be evaluated. Based on all the determined encoding costs (e.g. for the subset and the neighbors), the best modes may be updated. This second or final list of best modes candidates may be provided for further processing.

For example, the discussed encoding costs may be determined at a relatively low precision to save computational costs. For example, the candidate best modes may be selected based on encoding costs determined by comparing the original pixel data (e.g., original pixels of the current frame) of the current coding unit to predicted pixel data of the appropriate reference coding unit associated with the intra-prediction mode. Furthermore, available splits of the coding unit into smaller transform units may not be taken into account for such encoding cost determinations to save computational costs.

The list of best modes candidates may be further processed as discussed including evaluating the encoding costs of the candidates at a higher precision via full rate distortion optimization calculations (e.g., performing full prediction to determine residuals, transform, quantization, and bitstream encoding to determine the number of bits for the candidate, and inverse quantization, inverse transform, and distortion calculation such that full bit cost and distortion may be evaluated). Furthermore, such encoding costs evaluations may include evaluating all potential splits of the coding unit, which then takes into account all the best modes candidates and coding unit splits candidates. Such processing may be used to select the encoding mode (e.g., if only one mode is being used for the coding unit) or modes (e.g., if multiple modes are being used for the coding unit) for the coding unit. Such processing is computationally intensive, but the reduction of candidates from all those available to a list of best modes candidates may substantially reduce processing time while providing only a negligible loss of compression efficiency.

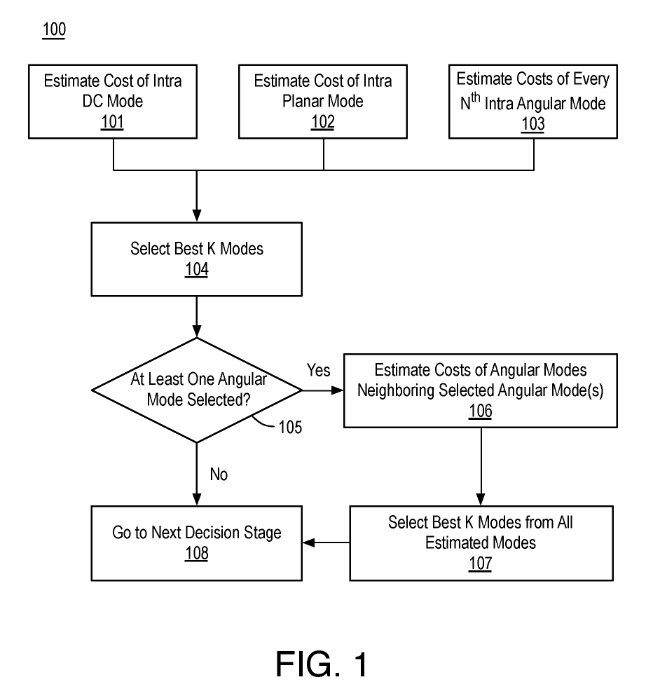

FIG. 1 is a flow diagram illustrating an example process 100 for providing candidate intra-prediction modes, arranged in accordance with at least some implementations of the present disclosure. Process 100 may include one or more operations 101-108 as illustrated in FIG. 1. Process 100 may be performed by a device (e.g., encoder 700 as discussed herein) to determine candidate intra-prediction modes, which may be further evaluated to determine intra-prediction encoding mode(s) for encoding a coding unit of a video frame, for example. Process 100 may be performed at the coding unit level and process 100 may be repeated for any number of coding units.

For example, in the context of High Efficiency Video Coding (HEVC), the HEVC standard defines a Coding Tree Unit (CTU) for a picture (e.g., video frame of a video sequence) that is then partitioned into Coding Units (CUs) that take the form of rectangular blocks having variable sizes. Within each CTU, a quad-tree based splitting scheme specifies the CU partition pattern. HECV also defines Prediction Units (PUs) and Transform Units (TUs) that specify how a given CU is to be partitioned for prediction and transform purposes, respectively. A CU ordinarily includes one luma Coding Block (CB) and two chroma CBs together with associated syntax, and a PU may be further divided into Prediction Blocks (PBs) ranging in size from 64×64 samples down to 4×4 samples. After intra or inter prediction, transform operations are applied to residual blocks to generate coefficients. The coefficients are then quantized, scanned into one-dimensional order and, finally, entropy encoded to generate an HEVC compliant bitstream.

Although discussed herein with respect to HEVC, the described techniques may be used in the context of any suitable video encoding system or standard or the like. For example, as used herein, the term coding unit is meant to include any partition of a picture or video frame that may be predicted using intra-prediction techniques. Such a partition may be described as a unit, block, or the like and such partitions may be square, rectangular, or any other suitable shape. Furthermore, the discussed techniques may be applied to luma units and/or chroma units.

As shown in FIG. 1, process 100 may begin at operation 101, “Estimate Cost of Intra DC Mode”, operation 102, “Estimate Cost of Intra Planar Mode”, and operation 103, “Estimate Costs of Every N^{th} Intra Angular Mode”. Such operations may be performed in any order or in parallel. For example, at operation 101, an encoding cost of an intra-prediction DC mode may be determined for a coding unit. The intra-prediction DC mode may include prediction based on a flat surface with a value matching the mean value of the boundary samples of the current coding unit. At operation 102, an encoding cost of an intra-prediction planar mode may be determined for the coding unit. For example, the intra-prediction planar mode may include prediction based on an assumed amplitude surface with horizontal and vertical slopes determined based on the boundary samples of the current coding unit. At operation 103, encoding costs of a subset of available intra-prediction angular modes may be determined.

The encoding costs determined at operations 101, 102, 103 may be determined using any suitable technique or techniques. In some examples, determining the encoding costs will exclude potential splits of the coding unit as discussed herein to save on computational complexity. In an embodiment, determining the encoding costs includes a comparison of original video frame pixels of the coding unit to predicted pixels of the coding units associated with the intra-prediction modes (e.g., for each of the intra-prediction modes). For example, determining the encoding cost of an intra-prediction angular mode may include a comparison of the original video frame pixels (e.g., pixel data such as luma data) of the coding unit to predicted pixels of the coding unit associated with the angular mode being evaluated. Furthermore, determining the encoding cost of the intra-prediction DC or planar modes may include a comparison of the original pixels (e.g., pixel data such as luma data) of the coding unit to approximated pixel data associated with the DC or planar mode, respectively. Such encoding costs evaluation techniques may provide for relatively low computational costs that are effective for early stage processing and evaluation of intra-prediction modes.

As discussed, at operation 103, encoding costs of only a subset of available intra-prediction angular modes may be determined. For example, in HEVC coding, 33 intra-prediction angular modes may be available for encoding.

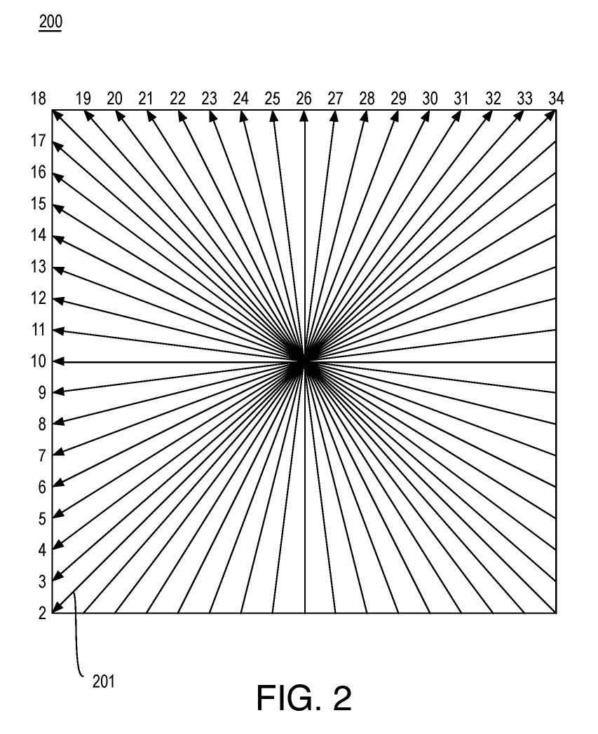

FIG. 2 is a diagram illustrating intra-prediction angular modes 200 including example available intra-prediction angular modes, arranged in accordance with at least some implementations of the present disclosure. As shown in FIG. 2, a video encoding structure or standard may provide available intra-prediction angular modes 201 (only one mode is labeled for the sake of clarity) indexed as modes 2-34. For example, mode 0 may be a planar mode and mode 1 may be a DC mode in this context. Available intra-prediction angular modes 201 may be associated with a prediction direction for example such that previously decoded coding units above and to the left of the current coding unit may be referenced for decoding the current coding unit. Such prediction directions may reference previously decoded pixel data or interpolated pixel data based on such previously decoded pixel data. As discussed, FIG. 2 illustrates example available intra-prediction angular modes 201.

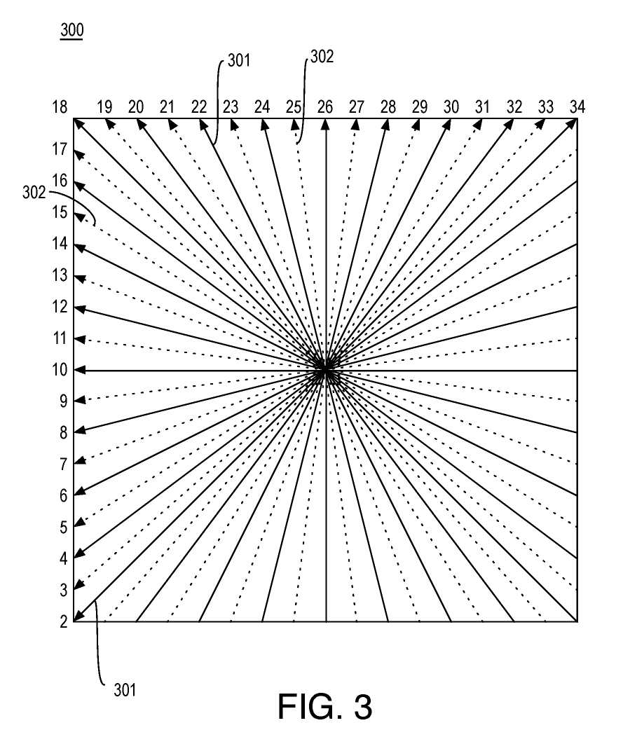

FIG. 3 is a diagram illustrating intra-prediction angular modes 300 including an example subset of available intra-prediction angular modes, arranged in accordance with at least some implementations of the present disclosure. As shown in FIG. 3, a subset 301 of available angular encoding modes may be determined. For example, subset 301 including angular modes represented with solid lines (e.g., modes 2, 4, 6, 8, 10, 12, 14, 16, 18, 20, 22, 24, 26, 28, 30, 32, and 34) may be evaluated to estimate their encoding costs as discussed with respect to operation 103. Also as shown in FIG. 3, the remaining subset 302 including angular modes represented with dotted lines may be available angular encoding modes but not currently used for evaluation of encoding costs.

As shown in FIG. 3, in an example, every other (e.g., every second; N=2) available angular encoding mode may be included in subset 301, however any suitable number of available angular encoding mode may be included in subset 301. In other examples, every third (e.g., N=3), fourth (e.g., N=4), fifth (e.g., N=5), or sixth (e.g., N=6) mode may be included for example. Furthermore, in the illustrated example, subset 301 is evenly distributed among the available angular encoding modes. In other examples, a skipping pattern may be established such that subset 301 may include angular modes that are bunched in various regions (e.g. to the left, above, or toward angular mode 18) of the available angular encoding modes. Furthermore, in some examples, the number or pattern of subset 301 may vary based on a mode of encoding (e.g., a low, medium, or high quality such that higher quality provides more angular modes in subset 301), a frame complexity (e.g., such that higher complexity may provides more angular modes in subset 301), or a size or complexity of the current coding unit (e.g., such that larger and/or more complex coding units may provide more angular modes in subset 301), or the like. In other examples, the number or pattern of subset 301 may be predetermined.

Returning to FIG. 1, process 100 may continue at operation 104, “Select Best K Modes”, where a number of candidate intra-prediction modes may be determined based on the encoding costs determined via operations 101, 102, 103. For example, the best K modes may be selected as those with the lowest encoding costs. Any number of modes may be selected at operation 104 such as, for example, 2 modes, 3 modes, 4 modes, 8 modes, or 10 modes or the like. In some examples, the number of selected modes may vary based on a mode of encoding (e.g., a low, medium, or high quality such that higher quality provides more selected modes), a frame complexity (e.g., such that higher complexity may provides more selected modes), or a size or complexity of the current coding unit, or the like.

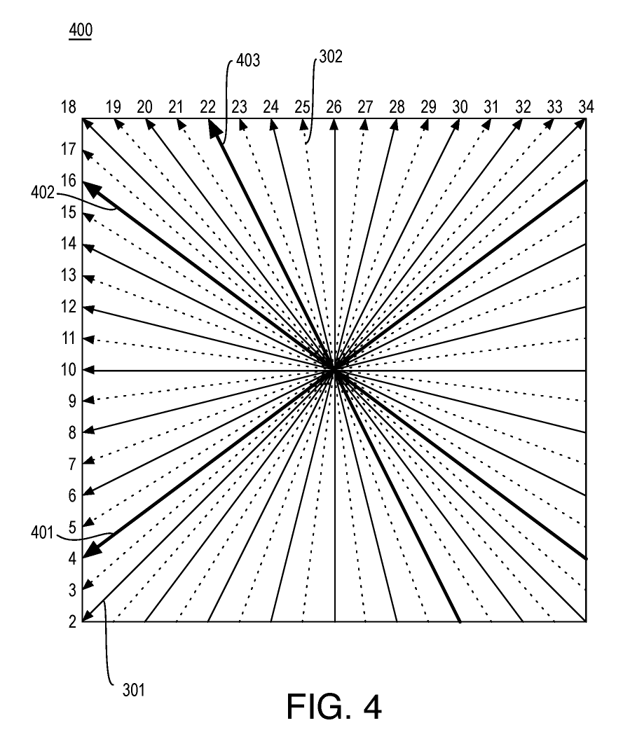

FIG. 4 is a diagram illustrating intra-prediction angular modes 400 including example selected intra-prediction angular modes, arranged in accordance with at least some implementations of the present disclosure. As shown in FIG. 4, subset 301 (e.g., shown as solid lines) of available angular encoding modes may have been evaluated and subset 302 (e.g., shown as dotted lines) may not have been evaluated or such modes may have been skipped. Furthermore, FIG. 4 illustrates selected intra-prediction angular modes 401, 402, 403 (e.g., shown as thick solid lines). For example, if the number of modes selected at operation 104 is four (e.g., K=4) and one of the selected modes was intra-prediction planar mode (e.g., mode 0), FIG. 4 illustrates an example where the remaining three modes selected at operation are intra-prediction angular mode 401 (e.g., mode 4), intra-prediction angular mode 402 (e.g., mode 16), and intra-prediction angular mode 403 (e.g., mode 22). Although illustrated with four modes selected at operation 104, as discussed, any suitable number of modes may have been selected and any suitable number of subset 302 may be provided as selected intra-prediction angular modes.

Returning to FIG. 1, process 100 may continue at decision operation 105, “At Least One Angular Mode Selected?”, where a determination may be made as to whether at least one angular mode was selected at operation 104. For example, if two best modes are used (e.g., K=2) and the intra-prediction planar mode and the intra-prediction DC mode are selected at operation 104, no angular mode may have been selected. As shown, if no angular modes was selected at operation 104, process 100 may continue at operation 108, “Go to the Next Decision Stage”, where processing may continue based on the candidate intra-prediction modes as is discussed further herein.

If at least one angular mode was selected at operation 104, process 100 may continue at operation 106, “Estimate Costs of Angular Modes Neighboring Selected Angular Mode(s)”, where encoding costs of neighbor(s) of selected angular mode(s) may be determined. The encoding costs determined at operation 106 may be determined using any suitable technique or techniques such as those discussed with respect to operations 101, 102, 103 above.

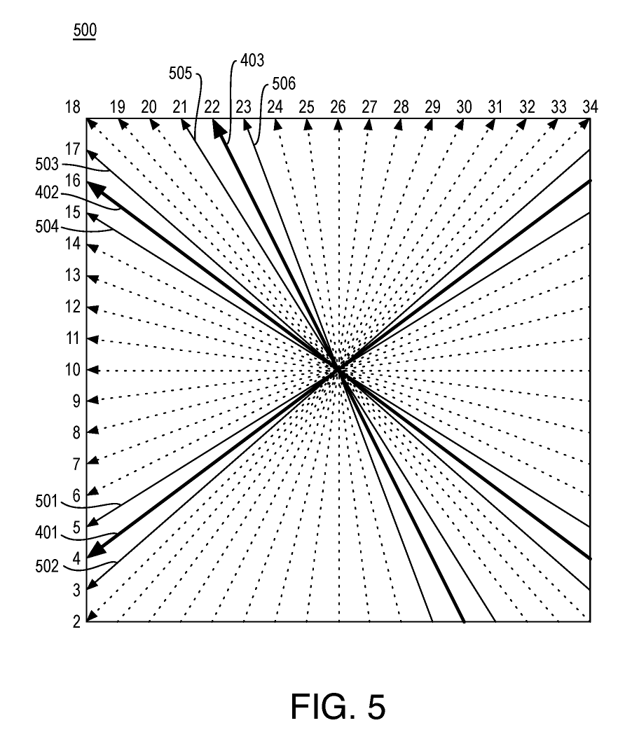

FIG. 5 is a diagram illustrating intra-prediction angular modes 500 including example selected intra-prediction angular modes and example neighboring intra-prediction angular modes, arranged in accordance with at least some implementations of the present disclosure. As shown in FIG. 5, one or more neighbors of selected intra-prediction angular modes 401, 402, 403 such as intra-prediction angular modes 501, 502 (e.g., neighbors of selected intra-prediction angular mode 401), intra-prediction angular modes 503, 504 (e.g., neighbors of selected intra-prediction angular mode 402), and intra-prediction angular modes 505, 506 (e.g., neighbors of selected intra-prediction angular mode 403) may be evaluated at operation 104.

In the example of FIG. 5, both immediate neighbors of previously selected intra-prediction angular modes may be evaluated. In other examples, only one neighbor may be evaluated. For example, the evaluated neighbor may have an index of one greater than the previously selected intra-prediction angular mode or one less. Furthermore, in the examples of mode 2 or mode 34 being previously selected, only one neighbor may be available for evaluation. In yet other examples, non-immediate neighbors may also be evaluated. For example, immediate neighbors and one or more additional extended neighbors may also be evaluated. For example, when N=3 or more, such extended neighbors may be available for evaluation. (In examples where N=2, such extended neighbors have already been evaluated, please refer to FIG. 3). The determination of the number of evaluated neighbors (e.g., only one, both immediate neighbors, or immediate and extended neighbors) may balance increased coding efficiency (e.g., greater compression) against increased computing costs (e.g., as more neighbors are evaluated).

Returning to FIG. 1, processing may continue at operation 107, “Select Best K Modes from All Estimated Modes”, where a number of candidate intra-prediction modes may be determined based on the encoding costs determined via operations 101, 102, 103, 106. For example, the best K modes may be selected as those with the lowest encoding costs. As discussed with respect to operation 104, any number of modes may be selected at operation 107 such as, for example, 2 modes, 3 modes, 4 modes, 8 modes, or 10 modes or the like. In some examples, the number of selected modes may vary based on a mode of encoding (e.g., a low, medium, or high quality such that higher quality provides more selected modes), a frame complexity (e.g., such that higher complexity may provides more selected modes), or a size or complexity of the current coding unit (e.g., such that larger or more complex coding units provide more selected modes), or the like. As illustrated, in some examples, the number of candidates selected at operation 107 may be the same number of candidates selected at operation 104. In other examples, the number of candidates selected at operation 107 may be different than the number of candidates selected at operation 104.

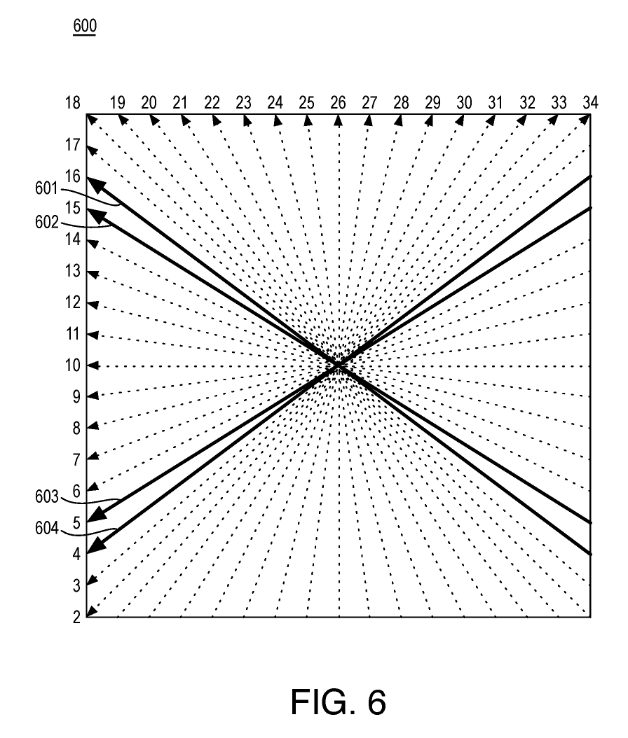

FIG. 6 is a diagram illustrating intra-prediction angular modes 600 including example candidate intra-prediction angular modes, arranged in accordance with at least some implementations of the present disclosure. FIG. 6 illustrates selected candidate intra-prediction angular modes 601, 602, 603, 604. For example, FIG. 6 illustrates the results if the number of modes selected at operation 107 is four (e.g., K=4), the previously selected intra-prediction planar mode and intra-prediction angular mode 22 were not selected at operation 107 (please also refer to FIG. 4), and previously selected intra-prediction angular modes 4 and 16 and newly selected intra-prediction angular modes 5 and 15 were selected at operation 107. Although illustrated with four modes selected at operation 104, as discussed, any suitable number of modes may have been selected and any suitable number of subset 302 may be provided as selected intra-prediction angular modes at operation 107. Furthermore, the combinations of selected, neighboring, and candidate angular modes discussed with respect to FIGS. 4-6 are for illustrative purposes only and are not meant to be limiting.

Returning to FIG. 1, processing may continue from operation 107 or from decision operation 105 at operation 108, “Go to Next Decision Stage”, where processing may continue based on the selected candidate intra-prediction modes. For example, a first or preliminary set of candidate best modes may be determined at operation 104 and a second or final set of candidate best modes may be determined at operation 107. Such second or final set of candidate best modes may be provided for additional processing such that one or more encoding modes may be selected for the coding unit. Such additional processing may include evaluating more accurate encoding costs for the candidate encoding modes and/or evaluating such encoding costs for available splits of the coding unit. As discussed, for example, the additional processing may include full rate distortion optimization calculations such as performing full prediction of the coding unit to determine residuals, transform, quantization, and bitstream encoding to determine the number of bits for the candidate mode and/or split, and inverse quantization, inverse transform, and distortion calculation such that full bit cost and distortion may be evaluated. As discussed, the computational cost of encoding using the pre-selection or pre-stage processing that eliminates and refines available intra-prediction modes to a list of candidate intra-prediction modes may be substantially less than the computational cost of evaluating all available intra-prediction modes.

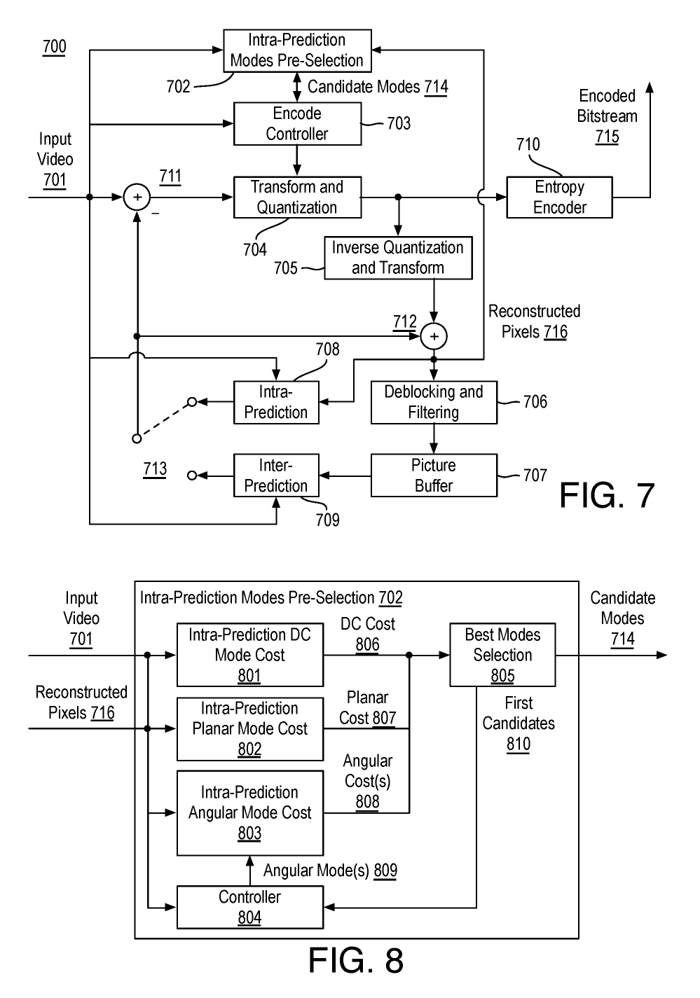

FIG. 7 illustrates a block diagram of an example encoder 700, arranged in accordance with at least some implementations of the present disclosure. As shown, encoder 700 may include an intra-prediction modes pre-selection module 702, an encode controller 703, a transform and quantization module 704, an inverse quantization and transform module 705, a deblocking and filtering module 706, a picture buffer 707, an intra-prediction module 708, an inter-prediction module 709, and an entropy encoder 710. Encoder 700 may include additional modules and/or interconnections that are not shown for the sake of clarity.

As discussed herein, pre-selection or pre-stage processing may be provided to select candidate intra-prediction modes. Such pre-selection may use a lower accuracy of encoding cost calculation and may not evaluate all possible splits of coding units. Also as discussed, such candidate intra-prediction modes may be further evaluated using a more accurate (and computationally complex) encoding cost calculation and/or evaluate all possible splits of the coding units. For example, intra-prediction modes pre-selection module 702 may generate candidate modes 714, which may be further evaluated via encode controller 703 and/or other modules of encoder 700 as is discussed further herein.

As shown in FIG. 7, encoder 700 may receive input video 701. Input video 701 may be in any suitable format and may be received via any suitable technique such as video capture or via memory or the like. Furthermore, input video 701 may be processed (not shown) to determine coding units, processing units, transform units, or the like as discussed herein. As shown, input video 701 may be provided to intra-prediction modes pre-selection module 702, encode controller 703, intra-prediction module 708, and inter-prediction module 709. The coupling to intra-prediction module 708 or inter-prediction module 709 may be made via a switch 713 as shown. Inter-prediction module 709 may perform motion estimation and/or motion compensation for pictures or frames of input video 701 coded via inter-prediction techniques. Intra-prediction module 708 may perform intra-prediction for pictures or frames of input video 701. As is discussed further herein, reconstructed pixels 716 may be provided from adder 712 to intra-prediction module 708 and intra-prediction modes pre-selection module 702. For example, reconstructed pixels 716 may include reconstructed pixels for a neighboring blocks or coding units of a current coding unit. For example, intra-predicted coding unit(s) from intra-prediction module 708 may be differenced with original pixel data for the coding unit(s) via differencer 711 to generate residual(s) which may be transformed an quantized via transformation and quantization module 704 and subsequently inverse transformed and inverse quantized via inverse quantization and transformation module 705 and added to the intra-predicted coding unit(s) via adder 712 to generate reconstructed pixels 716. Such reconstructed pixels 716 (e.g., neighboring a current coding unit) may be used to predict the current coding unit. Intra-prediction modes pre-selection module 702 may generate intra-prediction candidate modes 714 as discussed herein and provide such candidate as a candidate list or the like to encode controller 703.

FIG. 8 illustrates a block diagram of an example intra-prediction modes pre-selection module 702, arranged in accordance with at least some implementations of the present disclosure. As shown in FIG. 8, intra-prediction modes pre-selection module 702 may include an intra-prediction DC mode cost module 801, an intra-prediction planar mode cost module 802, an intra-prediction angular mode cost module 803, a best modes selection module 805, and a controller 804. As shown, intra-prediction modes pre-selection module 702 may receive input video 701 or portions thereof (e.g., only intra-frames of input video 701) and reconstructed pixels 716 of neighbor blocks or coding units for example. As shown, input video 701 (or portions thereof such as intra-frames) and reconstructed pixels 716 of neighbor blocks or coding units may be provided to intra-prediction DC mode cost module 801, which may generate an intra-prediction DC mode encoding cost (DC cost) 806 for a coding unit or the like of input video 701 using any technique as discussed herein. For example, intra-prediction DC mode cost module 801 may implement operation 101 as discussed herein with respect to process 100 to generate DC mode encoding cost 806. In an embodiment, intra-prediction DC mode cost module 801 may determine DC mode encoding cost 806 based on a comparison of pixel data for the coding unit to pixel data of a DC predicted reference unit (e.g., pixel data based on a flat surface with a value matching the mean value of the boundary samples of the current coding unit or the like). Furthermore, input video 701 and reconstructed pixels 716 of neighbor blocks or coding units may be provided to intra-prediction planar mode cost module 802, which may generate an intra-prediction planar mode encoding cost (planar cost) 807 for a coding unit or the like of input video 701 using any technique as discussed herein. For example, intra-prediction planar mode cost module 802 may implement operation 102 as discussed herein with respect to process 100 to generate planar mode encoding cost 807. In an embodiment, intra-prediction planar mode cost module 802 may determine planar mode encoding cost 807 based on a comparison of pixel data for the coding unit to pixel data of a planar predicted reference unit (e.g., pixel data based on an assumed amplitude surface with horizontal and vertical slopes determined based on the boundary samples of the current coding unit or the like).

Also as shown, input video 701 and reconstructed pixels 716 of neighbor blocks or coding units may be provided to intra-prediction angular mode cost module 803, which may determine encoding costs for a subset of available intra-prediction modes as discussed herein to generate intra-prediction angular mode(s) encoding cost(s) (angular cost(s)) 808. For example, intra-prediction angular mode cost module 803 may implement operation 103 as discussed herein with respect to process 100 to generate angular mode(s) encoding cost(s) 808. In an embodiment, angular mode(s) encoding cost(s) 808 may be determined based on a comparison of pixel data for the coding unit to pixel data of a reference unit (e.g., a reference coding unit determined based on the associated angular mode and reconstructed pixels 716). As discussed, in various examples, the size or shape of the subset of available angular modes (e.g., please refer to the discussion associated with FIG. 4) may be predetermined or it may be varied based on an encoding mode, a frame complexity, or a coding unit size or complexity or the like. In such examples, the size or shape of the subset may be determined by controller 804 implemented via intra-prediction modes pre-selection module 702 and communicated to intra-prediction angular mode cost module 803 via angular mode(s) 809 such that angular mode(s) 809 may include an index of listing or the like of angular mode(s) for which costs are currently requested. In another example, the size or shape of the subset may be determined by encode controller 703 (please refer to FIG. 7) and communicated to intra-prediction angular mode cost module 803 and/or controller 804.

As shown, DC mode encoding cost 806, planar mode encoding cost 807, and angular mode(s) encoding cost(s) 808 may be provided to best modes selection module 805. Best modes selection module 805 may determine a number of best modes based on the received costs. For example, best modes selection module 805 may implement operation 104 as discussed with respect to process 100 to determine a first candidate list of intra-prediction modes including K best modes. As shown, the first candidate list may be provided to controller 804 via first candidates 810. Furthermore, best modes selection module 805 may retain (e.g., via memory), first candidates 810 and their associated encoding costs for further evaluation as is discussed below. Based on first candidates 810, controller 804 may determine one or more neighbors of selected angular modes for cost evaluation. For example, controller 804 may determine those neighbors of the selected angular modes to be evaluated via intra-prediction angular mode cost module 803. Controller may transfer the neighboring angular modes to be evaluated via angular mode(s) 809 to intra-prediction angular mode cost module 803.

Intra-prediction angular mode cost module 803 may determine encoding costs for the neighboring angular modes and transfer the encoding costs to best modes selection module 805 via angular mode(s) encoding cost(s) 808. Best modes selection module 805 may receive the encoding costs for the neighboring angular modes and retrieve encoding costs for first candidates 810 via memory. Best modes selection module 805 may then determine a number of best modes based on the encoding costs for first candidates 810 and the received encoding costs for the neighboring angular modes. For example, best modes selection module 805 may implement operation 107 as discussed with respect to process 100 to determine a second or final candidate list of intra-prediction modes including K best modes for the current coding unit. As shown, the second or final candidate list may be provided to encode controller 703 via candidate modes 714 (please refer to FIG. 7). The operations discussed with respect to intra-prediction modes pre-selection module 702 may be repeated for any number of coding units and/or any number of pictures or frames of input video 701.

Returning to FIG. 7, encode controller 703 may receive candidate modes 714 for the coding unit(s). Encode controller 703 may implement the determination of encoding costs for candidate modes 714 such that the encoding costs are more accurate than the encoding costs determined via intra-prediction modes pre-selection module 702. Furthermore, the encoding costs determined via encode controller 703 and/or other modules of encoder 700 may include encoding costs for various candidate splits of the coding unit(s). Such candidate splits may each be evaluated to determine an encoding mode or modes for the coding unit and transform splits (e.g., to generate transform units) for the coding unit. In some examples, a single intra-prediction coding mode may be provided for the coding unit such that each transform unit must use the assigned intra-prediction coding mode. In other examples, multiple intra-prediction coding modes may be assigned to a coding unit such that each transform unit may be associated with one of the modes (and such that different transform units of the same coding unit may have differing modes).

In an embodiment, encode controller 703 may determine such encoding costs by performing full prediction of the coding unit (and, if applicable, transform unit splits of the coding unit) via intra-prediction module 708 for each candidate intra-prediction coding mode and/or candidate transform splits. The intra-predicted coding unit may be differenced via differencer 711 with the original coding unit (e.g., of input video 701) to generate a residual. The residual may be transferred to transform and quantization module 704, which may transform (e.g., via a discrete cosine transform or the like) the residual to determine transform coefficients and quantize the transform coefficients. The quantized transform coefficients may be encoded via entropy encoder 710 and the number of bits may be counted as a bit cost (e.g., rate) for the particular candidate intra-prediction coding mode and/or splits for the coding unit.

Furthermore, the quantized transform coefficients may be inverse quantized and inverse transformed via inverse quantization and transform module 705 to generate a reconstructed residual. The reconstructed residual may be combined with the aforementioned intra-predicted coding unit at adder 712 to form a reconstructed coding unit, which may be optionally deblocked and filtered via deblocking and filtering module 706 and/or optionally saved (along with other reconstructed coding units of the current frame or picture) via picture buffer 707. The resultant reconstructed coding unit may be evaluated for distortion by comparison to the original coding unit (e.g., via input video 701).

Such a process may be repeated for each candidate intra-prediction mode and/or transform splits and a best intra-prediction mode or modes and/or transform splits may be determined based on a rate-distortion optimization analysis. For example, discussed rate and distortion may be characterized as an encoding cost and the best intra-prediction mode may be characterized as an encoding intra-prediction mode as discussed herein. The coding unit (e.g., as a part of a video frame) may be encoded based on the encoding intra-prediction mode and the resultant bits may be included in encoded bitstream 715. For example, intra-prediction module 708 may generate an intra-predicted coding unit using the selected intra-prediction encoding mode(s) and/or transform unit splits. The intra-predicted coding unit may be differenced via differencer 711 with the original coding unit (e.g., of input video 701) to generate a residual. The residual may be transformed to determine transform coefficients, which may be quantized and encoded into encoded bitstream 715. For example, a video frame of input video 701 may be encoded based at least in part on the encoding intra-prediction mode to generate encoded bitstream 715.

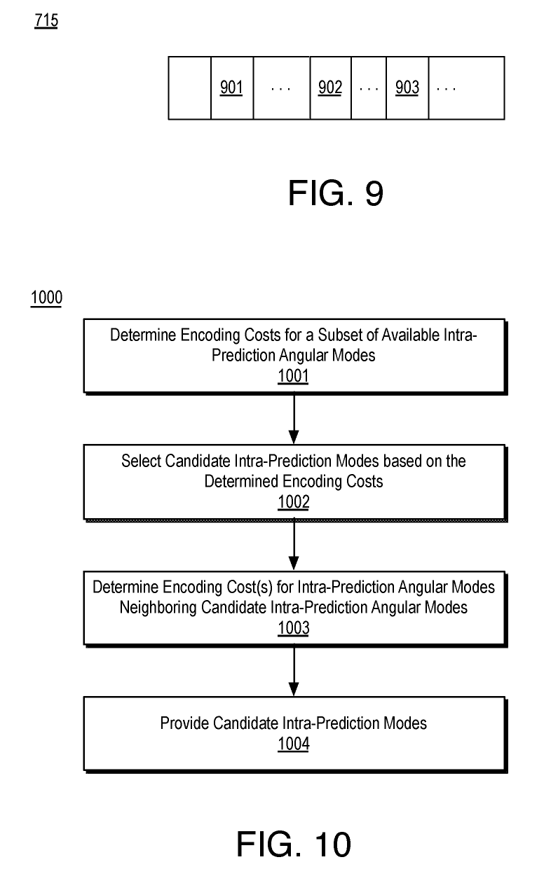

FIG. 9 illustrates an example encoded bitstream 715, arranged in accordance with at least some implementations of the present disclosure. In some examples, encoded bitstream 715 may be a High Efficiency Video Coding (HEVC) compliant bitstream. Although not shown in FIG. 9, in some examples, encoded bitstream 715 may include a header portion or portions and a data portion or portions. Encoded bitstream 715 may include any suitable data associated with encoded video data. As shown in FIG. 9, encoded bitstream 715 may include encoded quantized transform coefficients 901, encoded intra-prediction modes data 902, and encoded splits data 903. As discussed, encoded bitstream 715 may be generated via entropy encoder 710 of encoder 700.

For example, encoded bitstream 715 may include encoded quantized transform coefficients 901 that include transform coefficients for a residual of a coding unit and/or transform units as discussed herein. For example, a coding unit may be encoded based on an encoding intra-prediction mode selected as discussed herein. The residual between the predicted coding unit and the original coding unit may be transformed, quantized, encoded, and inserted into encoded bitstream as encoded quantized transform coefficients 901. Encoded bitstream 715 may also include encoded intra-prediction modes data 902. For example, encoded intra-prediction modes data 902 may include an intra-prediction mode or modes for a coding unit selected as discussed herein. The selected intra-prediction mode or modes for a coding unit may be entropy encoded and inserted into encoded bitstream 715 as encoded intra-prediction modes data 902. Furthermore, encoded bitstream 715 may include encoded splits data 903. As discussed herein, for a coding unit, intra-prediction mode or modes may be selected and a split of the coding unit (e.g., into transform units) may also be selected. Such split data may be determined for the coding unit as discussed herein via evaluating coding costs for the candidate intra-prediction modes and candidate splits. The selected split or splits for the coding unit may be entropy encoded and inserted into encoded bitstream 715 as encoded splits data 903. As discussed, encoded bitstream 715 may be generated via an encoder or encoder system such as, for example, encoder 700. Encoded bitstream 715 may be stored (e.g., as a file or container) to a memory (e.g., of system a system implementing encoder 700), stored (e.g., as a file or container) to a memory storage device (e.g., a disc, a server for download, or the like), or transmitted to a remote device. Furthermore, encoded bitstream 715 may be accessed (e.g., via reading a disc, streaming, downloading, or the like) by a decoder that may decode the bitstream and generate video frames or sequences of video frames for presentment to a user.

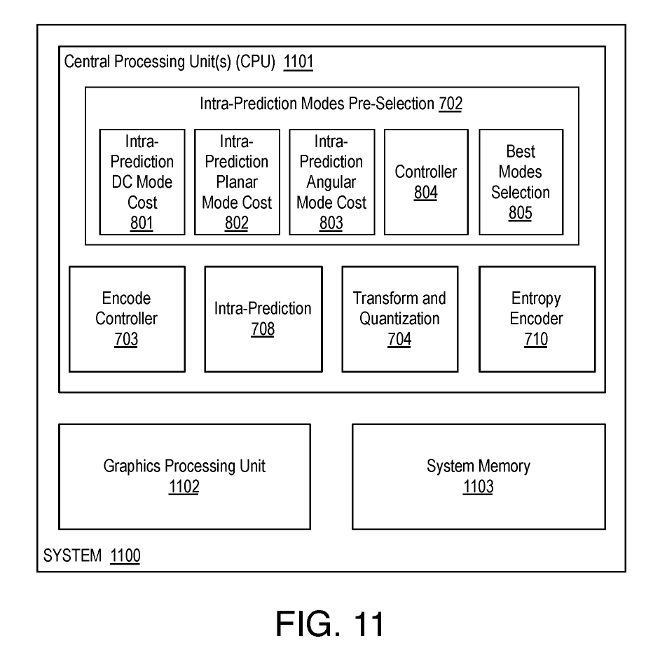

FIG. 10 is a flow diagram illustrating an example process 1000 for video encoding, arranged in accordance with at least some implementations of the present disclosure. Process 1000 may include one or more operations 1001-1004 as illustrated in FIG. 10. Process 1000 may form at least part of a video encoding process. By way of non-limiting example, process 1000 may form at least part of a video encoding process for generating candidate intra-prediction modes such as candidate modes 714 as undertaken by encoder 700 as discussed herein. Further, process 1000 will be described herein in reference to system 1100 of FIG. 11.

FIG. 11 is an illustrative diagram of an example system 1100 for video encoding, arranged in accordance with at least some implementations of the present disclosure. As shown in FIG. 11, system 1100 may include one or more central processing units (CPU) 1101, a graphics processing unit (GPU) 1102, and system memory 1103. Also as shown, CPU 1101 may include intra-prediction modes pre-selection module 702, encode controller 703, intra-prediction module 708, transform and quantization module 704, and entropy encoder 710. Furthermore, intra-prediction modes pre-selection module 702 may include intra-prediction DC mode cost module 801, intra-prediction planar mode cost module 802, intra-prediction angular mode cost module 803, controller 804, and best modes selection module 805. In the example of system 1100, system memory 1103 may store video data such as input video 701, encoding costs 806, 807, 808, angular mode(s) 809, first candidates 810, candidate modes 714, encoded bitstream 715, or other video data discussed herein such as residuals, transform coefficients, encoding parameters, or the like.

CPU 1101 and graphics processing unit 1102 may include any number and type of processing units that may provide the operations as discussed herein. Such operations may be implemented via software or hardware or a combination thereof. For example, graphics processing unit 1102 may include circuitry dedicated to manipulate data obtained from system memory 1103 or dedicated graphics memory (not shown). Furthermore, central processing units 1101 may include any number and type of processing units or modules that may provide control and other high level functions for system 1100 as well as the operations as discussed herein. System memory 1103 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, system memory 1103 may be implemented by cache memory. As shown, in an embodiment, intra-prediction modes pre-selection module 702, encode controller 703, intra-prediction module 708, transform and quantization module 704, and entropy encoder 710 may be implemented via CPU 1101. In some examples, intra-prediction modes pre-selection module 702, encode controller 703, intra-prediction module 708, transform and quantization module 704, and entropy encoder 710 may be provided by software as implemented via CPU 1101. In other examples, intra-prediction modes pre-selection module 702, encode controller 703, intra-prediction module 708, transform and quantization module 704, and entropy encoder 710 may be implemented via a digital signal processor or the like. In another embodiment, intra-prediction modes pre-selection module 702, encode controller 703, intra-prediction module 708, transform and quantization module 704, and entropy encoder 710 may be implemented via an execution unit (EU) of graphics processing unit 1102. The EU may include, for example, programmable logic or circuitry such as a logic core or cores that may provide a wide array of programmable logic functions.

Returning to discussion of FIG. 10, process 1000 may begin at operation 1001, “Determine Encoding Costs for a Subset of Available Intra-Prediction Angular Modes”, where, for a coding unit of a video frame, an encoding cost may be determined for each of only a subset of available intra-prediction angular modes. For example, encoding costs associated with the subset of intra-prediction angular modes may be determined. For example, angular mode(s) encoding cost(s) 808 may be determined for a subset 301 of available intra-prediction angular modes 201 via intra-prediction angular mode cost module 803 of intra-prediction modes pre-selection module 702 as implemented via CPU 1101. In some examples, the encoding costs include a comparison of video frame pixels (e.g., pixel values) of the coding unit to video frame pixels (e.g., pixel values) of reference coding units (e.g., predicted pixels of the coding unit) associated with the subset of intra-prediction angular modes. As discussed, in various examples, the subset may include every second, third, fourth, or more of the available intra-prediction angular modes. The subset of the available intra-prediction angular modes may be predetermined or determined based on encoding modes, frame complexity, or coding unit complexity or size, or the like. Furthermore, at operation 1001, encoding costs for intra-prediction DC mode and intra-prediction planar mode may be determined as discussed herein.

Process 1000 may continue at operation 1002, “Select Candidate Intra-Prediction Modes based on the Determined Encoding Costs”, where first candidate intra-prediction modes may be selected based on the determined encoding costs. For example the first candidate intra-prediction modes may include one or more of the subset of intra-prediction angular modes. For example, first candidates 810 may be determined by best modes selection module 805 of intra-prediction modes pre-selection module 702 as implemented via CPU 1101. In some examples, the best modes may be associated with the lowest encoding costs.

Process 1000 may continue at operation 1003, “Determine Encoding Cost(s) for Intra-Prediction Angular Modes Neighboring Candidate Intra-Prediction Angular Modes”, where encoding costs may be determined for one or more intra-prediction angular modes neighboring a selected intra-prediction angular mode. For example, angular mode(s) encoding cost(s) 808 may be determined for the neighboring intra-prediction angular mode(s) via intra-prediction angular mode cost module 803 of intra-prediction modes pre-selection module 702 as implemented via CPU 1101. In an example, the neighboring intra-prediction angular mode(s) may be both (if available) immediate neighbors of a selected intra-prediction angular mode.

Process 1000 may continue at operation 1004, “Provide Candidate Intra-Prediction Modes”, where second candidate intra-prediction modes may be selected based on the determined encoding costs and provided for further processing. For example the final or second candidate intra-prediction modes may include one or more of the subset of intra-prediction angular modes and/or one or more of the neighboring intra-prediction angular modes. For example, candidate modes 714 may be determined by best modes selection module 805 of intra-prediction modes pre-selection module 702 as implemented via CPU 1101 and candidate modes 714 may be provided to encode controller 703 of encoder 700. In some examples, the best modes may be associated with the lowest encoding costs.

Process 1000 may be repeated any number of times either in series or in parallel for any number of coding units and/or video pictures or frames (e.g., intra-frames). Process 1000 may provide for candidate intra-prediction modes via a device such as encoder 700 or any other system or device as discussed herein. As discussed, such candidate intra-prediction modes may be further evaluated to determine an encoding intra-prediction mode and/or splits for the coding unit. For example, more accurate encoding costs may be determined for the candidate intra-prediction modes to determine the encoding intra-prediction mode and/or splits by encode controller 703 as implemented via CPU 1101. For example, encode controller 703 may determine such encoding costs and select such an encoding intra-prediction mode and/or splits via data received by other modules of encoder 700 (as discussed) implemented via CPU 1101. The more accurate encoding costs and encoding intra-prediction mode selection may be performed based on a rate-distortion optimization for example. Based on the encoding intra-prediction mode and/or splits, the coding unit may be encoded as discussed herein to, in part, generate encoded bitstream 715. In an embodiment, the encoded bitstream is a High Efficiency Video Coding (HEVC) compliant bitstream. For example, the coding unit may be encoded by entropy controller 710 as implemented via CPU 1101.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of encoder 700, system 1100, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As discussed, encoding using the discussed pre-selection or pre-stage processing to generate a list of candidate intra-prediction modes for further processing may provide complexity reduction and substantial computational cost savings with only negligible compression losses. For example, the discussed techniques of intra-prediction angular modes elimination and subsequent refinement may provide an average of 7.6% encoding time reduction at a negligible cost of 0.04% rate increase. Table 1 illustrates example results for various test video clips.

TABLE 1
Example Rate Increases and Encoding Time Reductions

| | | Delta Encode |
|---|---|---|
| YUV Clip | BD-Rate, % | Time, % |
| basketball_drill_832x480p_501 | −0.00 | −9.63 |
| basketball_drive_1920x1080p_501 | +0.12 | −7.71 |
| basketball_pass_416x240p_501 | +0.12 | −7.92 |
| blowing_bubbles_416x240p_501 | +0.01 | −8.93 |
| bq_mall_832x480p_600 | +0.04 | −6.38 |
| bq_square_416x240p_601 | +0.07 | −6.33 |
| bq_terrace_1920x1080p_601 | +0.02 | −6.86 |
| cactus_1920x1080p_500 | +0.08 | −8.18 |
| kimono1_1920x1080p_240 | +0.03 | −7.47 |
| park_scene_1920x1080p_240 | −0.04 | −6.53 |
| party_scene_832x480p_501 | +0.03 | −6.53 |
| race_horses_416x240p_301 | +0.10 | −7.49 |
| race_horses_832x480_300 | −0.04 | −8.54 |
| AVERAGE | +0.04 | −7.57 |

As shown in Table 1, the example YUV Clips may range in BD-Rate (e.g., Bjontegaard Distortion-Rate) from −0.04% to 0.12%, with an average of +0.04% and in Delta Encode Time from −6.33% to −9.63 with an average of −7.57%. Such results indicate the described techniques may save substantial encode time with a negligible rate increase.

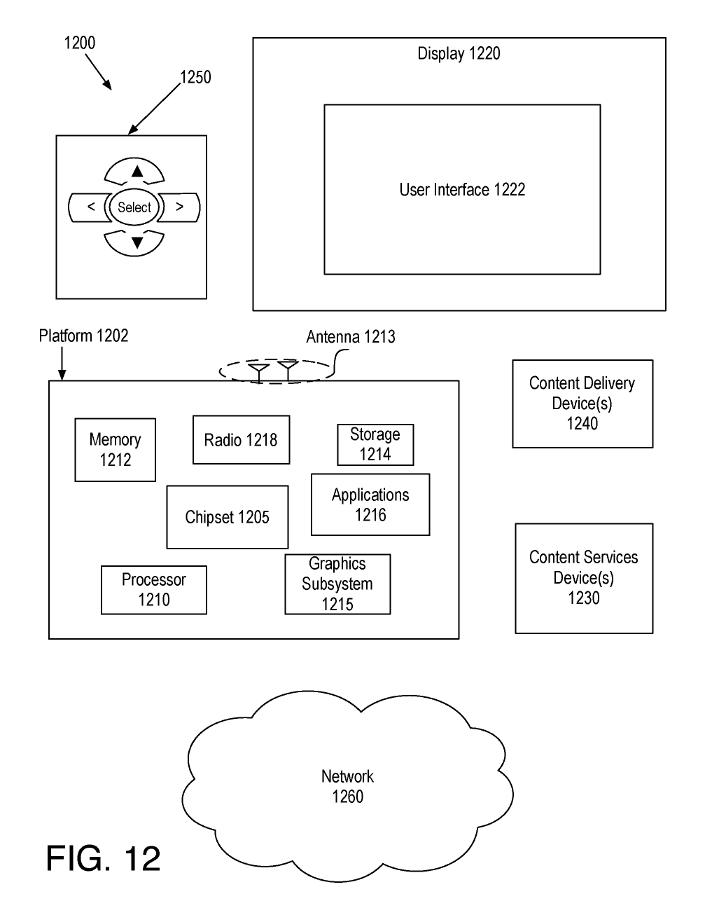

FIG. 12 is an illustrative diagram of an example system 1200, arranged in accordance with at least some implementations of the present disclosure. In various implementations, system 1200 may be a mobile system although system 1200 is not limited to this context. For example, system 1200 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, smart watch, smart glasses or smart television), mobile internet device (MID), messaging device, data communication device, cameras (e.g. point-and-shoot cameras, super-zoom cameras, digital single-lens reflex (DSLR) cameras, video cameras, camcorder), and so forth.

In various implementations, system 1200 includes a platform 1202 coupled to a display 1220. Platform 1202 may receive content from a content device such as content services device(s) 1230 or content delivery device(s) 1240 or other similar content sources. A navigation controller 1250 including one or more navigation features may be used to interact with, for example, platform 1202 and/or display 1220. Each of these components is described in greater detail below.

In various implementations, platform 1202 may include any combination of a chipset 1205, processor 1210, memory 1212, antenna 1213, storage 1214, graphics subsystem 1215, applications 1216 and/or radio 1218. Chipset 1205 may provide intercommunication among processor 1210, memory 1212, storage 1214, graphics subsystem 1215, applications 1216 and/or radio 1218. For example, chipset 1205 may include a storage adapter (not depicted) capable of providing intercommunication with storage 1214.

Processor 1210 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1210 may be dual-core processor(s), dual-core mobile processor(s), and so forth.

Memory 1212 may be implemented as a volatile memory device such as, but not limited to, a Random Access Memory (RAM), Dynamic Random Access Memory (DRAM), or Static RAM (SRAM).

Storage 1214 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1214 may include technology to increase the storage performance enhanced protection for valuable digital media when multiple hard drives are included, for example.

Graphics subsystem 1215 may perform processing of images such as still or video for display. Graphics subsystem 1215 may be a graphics processing unit (GPU) or a visual processing unit (VPU), for example. An analog or digital interface may be used to communicatively couple graphics subsystem 1215 and display 1220. For example, the interface may be any of a High-Definition Multimedia Interface, DisplayPort, wireless HDMI, and/or wireless HD compliant techniques. Graphics subsystem 1215 may be integrated into processor 1210 or chipset 1205. In some implementations, graphics subsystem 1215 may be a stand-alone device communicatively coupled to chipset 1205.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1218 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1218 may operate in accordance with one or more applicable standards in any version.

In various implementations, display 1220 may include any television type monitor or display. Display 1220 may include, for example, a computer display screen, touch screen display, video monitor, television-like device, and/or a television. Display 1220 may be digital and/or analog. In various implementations, display 1220 may be a holographic display. Also, display 1220 may be a transparent surface that may receive a visual projection. Such projections may convey various forms of information, images, and/or objects. For example, such projections may be a visual overlay for a mobile augmented reality (MAR) application. Under the control of one or more software applications 1216, platform 1202 may display user interface 1222 on display 1220.

In various implementations, content services device(s) 1230 may be hosted by any national, international and/or independent service and thus accessible to platform 1202 via the Internet, for example. Content services device(s) 1230 may be coupled to platform 1202 and/or to display 1220. Platform 1202 and/or content services device(s) 1230 may be coupled to a network 1260 to communicate (e.g., send and/or receive) media information to and from network 1260. Content delivery device(s) 1240 also may be coupled to platform 1202 and/or to display 1220.

In various implementations, content services device(s) 1230 may include a cable television box, personal computer, network, telephone, Internet enabled devices or appliance capable of delivering digital information and/or content, and any other similar device capable of uni-directionally or bi-directionally communicating content between content providers and platform 1202 and/display 1220, via network 1260 or directly. It will be appreciated that the content may be communicated uni-directionally and/or bi-directionally to and from any one of the components in system 1200 and a content provider via network 1260. Examples of content may include any media information including, for example, video, music, medical and gaming information, and so forth.

Content services device(s) 1230 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1202 may receive control signals from navigation controller 1250 having one or more navigation features. The navigation features of controller 1250 may be used to interact with user interface 1222, for example. In various embodiments, navigation controller 1250 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1250 may be replicated on a display (e.g., display 1220) by movements of a pointer, cursor, focus ring, or other visual indicators displayed on the display. For example, under the control of software applications 1216, the navigation features located on navigation controller 1250 may be mapped to virtual navigation features displayed on user interface 1222, for example. In various embodiments, controller 1250 may not be a separate component but may be integrated into platform 1202 and/or display 1220. The present disclosure, however, is not limited to the elements or in the context shown or described herein.

In various implementations, drivers (not shown) may include technology to enable users to instantly turn on and off platform 1202 like a television with the touch of a button after initial boot-up, when enabled, for example. Program logic may allow platform 1202 to stream content to media adaptors or other content services device(s) 1230 or content delivery device(s) 1240 even when the platform is turned “off” In addition, chipset 1205 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1200 may be integrated. For example, platform 1202 and content services device(s) 1230 may be integrated, or platform 1202 and content delivery device(s) 1240 may be integrated, or platform 1202, content services device(s) 1230, and content delivery device(s) 1240 may be integrated, for example. In various embodiments, platform 1202 and display 1220 may be an integrated unit. Display 1220 and content service device(s) 1230 may be integrated, or display 1220 and content delivery device(s) 1240 may be integrated, for example. These examples are not meant to limit the present disclosure.

In various embodiments, system 1200 may be implemented as a wireless system, a wired system, or a combination of both. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1202 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 12.

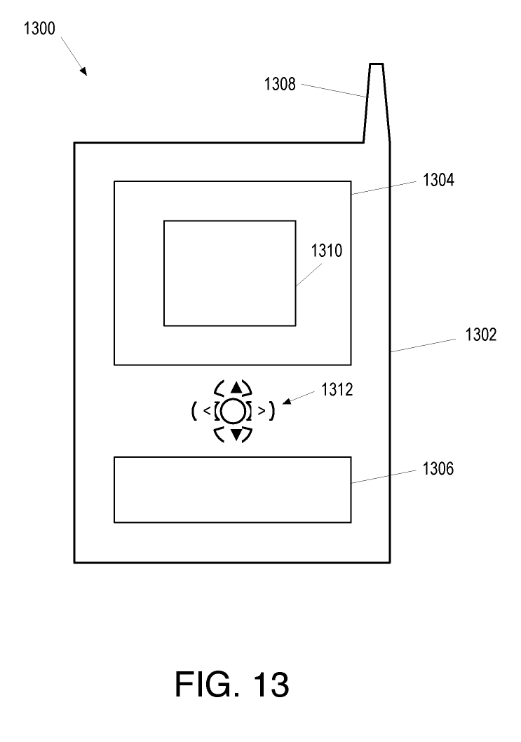

As described above, system 1200 may be embodied in varying physical styles or form factors. FIG. 13 illustrates an example device, arranged in accordance with at least some implementations of the present disclosure. For example, FIG. 13 illustrates implementations of a small form factor device 1300 in which system 1200 may be embodied. In various embodiments, for example, device 1300 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 13, device 1300 may include a housing 1302, a display 1304, an input/output (I/O) device 1306, and an antenna 1308. Device 1300 also may include navigation features 1312. Display 1304 may include any suitable display unit for displaying information appropriate for a mobile computing device. Display 1304 may include a touchscreen region 1310 for receiving I/O commands. In some examples, touchscreen region 1310 may be substantially the same size as display 1304. I/O device 1306 may include any suitable I/O device for entering information into a mobile computing device. Examples for I/O device 1306 may include an alphanumeric keyboard, a numeric keypad, a touch pad, input keys, buttons, switches, rocker switches, microphones, speakers, voice recognition device and software, and so forth. Information also may be entered into device 1300 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first embodiments, a computer-implemented method for video encoding comprises determining, for a coding unit of a video frame, an encoding cost for each of only a subset of a plurality of available intra-prediction angular modes to provide a plurality of first encoding costs associated with the subset of intra-prediction angular modes, selecting a plurality of first candidate intra-prediction modes based at least in part on the plurality of encoding costs, wherein the first candidate intra-prediction modes includes at least a first intra-prediction angular mode from the subset of intra-prediction angular modes, determining at least a second encoding cost for a second intra-prediction angular mode neighboring the first intra-prediction angular mode, and providing a plurality of second candidate intra-prediction modes including at least one of the first intra-prediction angular mode or the second intra-prediction angular mode.

Further to the first embodiments, the subset of intra-prediction angular modes comprise at least one of every second, every third, or every fourth intra-prediction angular mode of the available intra-prediction angular modes.

Further to the first embodiments, determining at least the second encoding cost for the second intra-prediction angular mode neighboring the first intra-prediction angular mode further comprises determining a third encoding cost for a third intra-prediction angular mode neighboring the first intra-prediction angular mode, wherein the second and third intra-prediction angular modes are both immediate neighbors of the first intra-prediction angular mode.

Further to the first embodiments, the method further comprises determining, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

Further to the first embodiments, the method further comprises determining a plurality of third encoding costs for the second candidate intra-prediction modes, wherein the third encoding costs comprise more accurate encoding costs than the first encoding costs.

Further to the first embodiments, the method further comprises at least one of determining, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode and/or determining a plurality of fifth encoding costs for the second candidate intra-prediction modes, wherein the fifth encoding costs comprise more accurate encoding costs than the first encoding costs.

Further to the first embodiments, the first encoding costs comprise a comparison of original video frame pixels of the coding unit to predicted pixels of the coding unit for each of the subset of intra-prediction angular modes.

Further to the first embodiments, the subset of intra-prediction angular modes comprise a predetermined subset of the available intra-prediction angular modes.

Further to the first embodiments, the first encoding costs comprise a comparison of original video frame pixels of the coding unit to predicted pixels of the coding unit for each of the subset of intra-prediction angular modes and/or the subset of intra-prediction angular modes comprise a predetermined subset of the available intra-prediction angular modes.

Further to the first embodiments, the subset of intra-prediction angular modes comprise every other intra-prediction angular mode of the available intra-prediction angular modes, wherein determining at least the second encoding cost for the second intra-prediction angular mode neighboring the first intra-prediction angular mode further comprises determining a third encoding cost for a third intra-prediction angular mode, wherein the second and third intra-prediction angular modes are both immediate neighbors of the first intra-prediction angular mode, and wherein the first and second candidate intra-prediction modes each comprise three intra-prediction modes.

Further to the first embodiments, the method further comprises determining a plurality of third encoding costs for the second candidate intra-prediction modes, selecting an encoding intra-prediction mode for the coding unit based at least in part on the third encoding costs, and encoding the video frame based at least in part on the encoding intra-prediction mode to generate an encoded bitstream.

Further to the first embodiments, the method further comprises determining a plurality of third encoding costs for the second candidate intra-prediction modes, selecting an encoding intra-prediction mode for the coding unit based at least in part on the third encoding costs, and encoding the video frame based at least in part on the encoding intra-prediction mode to generate an encoded bitstream, wherein the encoded bitstream comprises a High Efficiency Video Coding (HEVC) compliant bitstream.

In one or more second embodiments, a system for providing a video encoding comprises a memory configured to store video data and a central processing unit coupled to the memory, wherein the central processing unit comprises encoding cost evaluation circuitry configured to determine, for a coding unit of a video frame, an encoding cost for each of only a subset of a plurality of available intra-prediction angular modes to provide a plurality of first encoding costs associated with the subset of intra-prediction angular modes and intra-prediction modes selection circuitry configured to select a plurality of first candidate intra-prediction modes based at least in part on the plurality of encoding costs, wherein the first candidate intra-prediction modes includes at least a first intra-prediction angular mode from the subset of intra-prediction angular modes, wherein the encoding cost evaluation circuitry is further configured to determine at least a second encoding cost for a second intra-prediction angular mode neighboring the first intra-prediction angular mode, and wherein the intra-prediction modes selection circuitry is further configured to provide a plurality of second candidate intra-prediction modes including at least one of the first intra-prediction angular mode or the second intra-prediction angular mode.

Further to the second embodiments, the subset of intra-prediction angular modes comprise at least one of every second, every third, or every fourth intra-prediction angular mode of the available intra-prediction angular modes.

Further to the second embodiments, the encoding cost evaluation circuitry is further configured to determine a third encoding cost for a third intra-prediction angular mode neighboring the first intra-prediction angular mode, wherein the second and third intra-prediction angular modes are both immediate neighbors of the first intra-prediction angular mode.

Further to the second embodiments, the encoding cost evaluation circuitry is further configured to determine, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

Further to the second embodiments, the central processing unit further comprises encode controller circuitry configured to determine a plurality of third encoding costs for the second candidate intra-prediction modes, wherein the third encoding costs comprise more accurate encoding costs than the first encoding costs.

Further to the second embodiments, the first encoding costs comprise a comparison of original video frame pixels of the coding unit to predicted pixels of the coding unit for each of the subset of intra-prediction angular modes.

Further to the second embodiments, the subset of intra-prediction angular modes comprise a predetermined subset of the available intra-prediction angular modes.

Further to the second embodiments, the first encoding costs comprise a comparison of original video frame pixels of the coding unit to predicted pixels of the coding unit for each of the subset of intra-prediction angular modes and/or the subset of intra-prediction angular modes comprise a predetermined subset of the available intra-prediction angular modes.

Further to the second embodiments, the subset of intra-prediction angular modes comprise every other intra-prediction angular mode of the available intra-prediction angular modes, wherein the encoding cost evaluation circuitry is further configured to determine a third encoding cost for a third intra-prediction angular mode, wherein the second and third intra-prediction angular modes are both immediate neighbors of the first intra-prediction angular mode, and wherein the first and second candidate intra-prediction modes each comprise three intra-prediction modes.

Further to the second embodiments, the central processing unit further comprises encode controller circuitry configured to determine a plurality of third encoding costs for the second candidate intra-prediction modes and select an encoding intra-prediction mode for the coding unit based at least in part on the third encoding costs and entropy encoder circuitry configured to encode the video frame based at least in part on the encoding intra-prediction mode to generate an encoded bitstream.

Further to the second embodiments, the central processing unit further comprises encode controller circuitry configured to determine a plurality of third encoding costs for the second candidate intra-prediction modes and select an encoding intra-prediction mode for the coding unit based at least in part on the third encoding costs and entropy encoder circuitry configured to encode the video frame based at least in part on the encoding intra-prediction mode to generate an encoded bitstream, wherein the encoded bitstream comprises a High Efficiency Video Coding (HEVC) compliant bitstream.

In one or more third embodiments, a system for encoding video comprises means for determining, for a coding unit of a video frame, an encoding cost for each of only a subset of a plurality of available intra-prediction angular modes to provide a plurality of first encoding costs associated with the subset of intra-prediction angular modes, means for selecting a plurality of first candidate intra-prediction modes based at least in part on the plurality of encoding costs, wherein the first candidate intra-prediction modes includes at least a first intra-prediction angular mode from the subset of intra-prediction angular modes, means for determining at least a second encoding cost for a second intra-prediction angular mode neighboring the first intra-prediction angular mode, and means for providing a plurality of second candidate intra-prediction modes including at least one of the first intra-prediction angular mode or the second intra-prediction angular mode.

Further to the third embodiments, the subset of intra-prediction angular modes comprise at least one of every second, every third, or every fourth intra-prediction angular mode of the available intra-prediction angular modes and the system further comprises means for determining a third encoding cost for a third intra-prediction angular mode neighboring the first intra-prediction angular mode, wherein the second and third intra-prediction angular modes are both immediate neighbors of the first intra-prediction angular mode.

Further to the third embodiments, the system further comprises means for determining, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

Further to the third embodiments, the system further comprises means for determining a plurality of third encoding costs for the second candidate intra-prediction modes, means for selecting an encoding intra-prediction mode for the coding unit based at least in part on the third encoding costs, and means for encoding the video frame based at least in part on the encoding intra-prediction mode to generate an encoded bitstream.

Further to the third embodiments, the system further comprises means for determining a plurality of third encoding costs for the second candidate intra-prediction modes, means for selecting an encoding intra-prediction mode for the coding unit based at least in part on the third encoding costs, and means for encoding the video frame based at least in part on the encoding intra-prediction mode to generate an encoded bitstream, wherein the encoded bitstream comprises a High Efficiency Video Coding (HEVC) compliant bitstream.

In one or more fourth embodiments, at least one machine readable medium comprises a plurality of instructions that, in response to being executed on a computing device, cause the computing device to provide vide encoding by determining, for a coding unit of a video frame, an encoding cost for each of only a subset of a plurality of available intra-prediction angular modes to provide a plurality of first encoding costs associated with the subset of intra-prediction angular modes, selecting a plurality of first candidate intra-prediction modes based at least in part on the plurality of encoding costs, wherein the first candidate intra-prediction modes includes at least a first intra-prediction angular mode from the subset of intra-prediction angular modes, determining at least a second encoding cost for a second intra-prediction angular mode neighboring the first intra-prediction angular mode, and providing a plurality of second candidate intra-prediction modes including at least one of the first intra-prediction angular mode or the second intra-prediction angular mode.

Further to the fourth embodiments, the subset of intra-prediction angular modes comprise at least one of every second, every third, or every fourth intra-prediction angular mode of the available intra-prediction angular modes.

Further to the fourth embodiments, determining at least the second encoding cost for the second intra-prediction angular mode neighboring the first intra-prediction angular mode further comprises determining a third encoding cost for a third intra-prediction angular mode neighboring the first intra-prediction angular mode, wherein the second and third intra-prediction angular modes are both immediate neighbors of the first intra-prediction angular mode.

Further to the fourth embodiments, the at least one machine readable medium comprises further instructions that, in response to being executed on a computing device, cause the computing device to provide vide encoding by determining, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

Further to the fourth embodiments, the at least one machine readable medium comprises further instructions that, in response to being executed on a computing device, cause the computing device to provide vide encoding by determining a plurality of third encoding costs for the second candidate intra-prediction modes, wherein the first encoding costs comprise a comparison of video frame pixels of the coding unit to video frame pixels of reference coding units associated with the subset of intra-prediction angular modes, and wherein the third encoding costs comprise more accurate encoding costs than the first encoding costs.

Further to the fourth embodiments, the first encoding costs comprise a comparison of original video frame pixels of the coding unit to predicted pixels of the coding unit for each of the subset of intra-prediction angular modes.

Further to the fourth embodiments, the subset of intra-prediction angular modes comprise every other intra-prediction angular mode of the available intra-prediction angular modes, wherein determining at least the second encoding cost for the second intra-prediction angular mode neighboring the first intra-prediction angular mode further comprises determining a third encoding cost for a third intra-prediction angular mode, and wherein the second and third intra-prediction angular modes are both immediate neighbors of the first intra-prediction angular mode.

Further to the fourth embodiments, the at least one machine readable medium comprises further instructions that, in response to being executed on a computing device, cause the computing device to provide vide encoding by determining a plurality of third encoding costs for the second candidate intra-prediction modes, selecting an encoding intra-prediction mode for the coding unit based at least in part on the third encoding costs, and encoding the video frame based at least in part on the encoding intra-prediction mode to generate High Efficiency Video Coding (HEVC) compliant bitstream.

In one or more fifth embodiments, at least one machine readable medium may include a plurality of instructions that in response to being executed on a computing device, causes the computing device to perform a method according to any one of the above embodiments.

In one or more sixth embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

1-24. (canceled)

25. A computer-implemented method for video encoding comprising:
determining, for a coding unit of a video frame, an encoding cost for each of only a subset of a plurality of available intra-prediction angular modes to provide a plurality of first encoding costs associated with the subset of intra-prediction angular modes;
selecting a plurality of first candidate intra-prediction modes based at least in part on the plurality of encoding costs, wherein the first candidate intra-prediction modes includes at least a first intra-prediction angular mode from the subset of intra-prediction angular modes;
determining at least a second encoding cost for a second intra-prediction angular mode neighboring the first intra-prediction angular mode; and
providing a plurality of second candidate intra-prediction modes including at least one of the first intra-prediction angular mode or the second intra-prediction angular mode.

26. The method of claim 25, wherein the subset of intra-prediction angular modes comprise at least one of every second, every third, or every fourth intra-prediction angular mode of the available intra-prediction angular modes.

27. The method of claim 25, wherein determining at least the second encoding cost for the second intra-prediction angular mode neighboring the first intra-prediction angular mode further comprises determining a third encoding cost for a third intra-prediction angular mode neighboring the first intra-prediction angular mode, wherein the second and third intra-prediction angular modes are both immediate neighbors of the first intra-prediction angular mode.

28. The method of claim 25, further comprising:
determining, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

29. The method of claim 25, further comprising:
determining a plurality of third encoding costs for the second candidate intra-prediction modes, wherein the third encoding costs comprise more accurate encoding costs than the first encoding costs.

30. The method of claim 25, wherein the first encoding costs comprise a comparison of original video frame pixels of the coding unit to predicted pixels of the coding unit for each of the subset of intra-prediction angular modes.

31. The method of claim 25, wherein the subset of intra-prediction angular modes comprise a predetermined subset of the available intra-prediction angular modes.

32. The method of claim 25, wherein the subset of intra-prediction angular modes comprise every other intra-prediction angular mode of the available intra-prediction angular modes, wherein determining at least the second encoding cost for the second intra-prediction angular mode neighboring the first intra-prediction angular mode further comprises determining a third encoding cost for a third intra-prediction angular mode, wherein the second and third intra-prediction angular modes are both immediate neighbors of the first intra-prediction angular mode, and wherein the first and second candidate intra-prediction modes each comprise three intra-prediction modes.

33. The method of claim 25, further comprising:
determining a plurality of third encoding costs for the second candidate intra-prediction modes;
selecting an encoding intra-prediction mode for the coding unit based at least in part on the third encoding costs; and
encoding the video frame based at least in part on the encoding intra-prediction mode to generate an encoded bitstream.

34. The method of claim 33, wherein the encoded bitstream comprises a High Efficiency Video Coding (HEVC) compliant bitstream.

35. A system for providing a video encoding comprising:
a memory configured to store video data; and
a central processing unit coupled to the memory, wherein the central processing unit comprises:
encoding cost evaluation circuitry configured to determine, for a coding unit of a video frame, an encoding cost for each of only a subset of a plurality of available intra-prediction angular modes to provide a plurality of first encoding costs associated with the subset of intra-prediction angular modes; and
intra-prediction modes selection circuitry configured to select a plurality of first candidate intra-prediction modes based at least in part on the plurality of encoding costs, wherein the first candidate intra-prediction modes includes at least a first intra-prediction angular mode from the subset of intra-prediction angular modes,
wherein the encoding cost evaluation circuitry is further configured to determine at least a second encoding cost for a second intra-prediction angular mode neighboring the first intra-prediction angular mode, and
wherein the intra-prediction modes selection circuitry is further configured to provide a plurality of second candidate intra-prediction modes including at least one of the first intra-prediction angular mode or the second intra-prediction angular mode.

36. The system of claim 35, wherein the subset of intra-prediction angular modes comprise at least one of every second, every third, or every fourth intra-prediction angular mode of the available intra-prediction angular modes.

37. The system of claim 35, wherein the encoding cost evaluation circuitry is further configured to determine a third encoding cost for a third intra-prediction angular mode neighboring the first intra-prediction angular mode, wherein the second and third intra-prediction angular modes are both immediate neighbors of the first intra-prediction angular mode.

38. The system of claim 35, wherein the encoding cost evaluation circuitry is further configured to determine, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

39. The system of claim 35, wherein the central processing unit further comprises:
encode controller circuitry configured to determine a plurality of third encoding costs for the second candidate intra-prediction modes, wherein the third encoding costs comprise more accurate encoding costs than the first encoding costs.

40. The system of claim 35, wherein the first encoding costs comprise a comparison of original video frame pixels of the coding unit to predicted pixels of the coding unit for each of the subset of intra-prediction angular modes.

41. The system of claim 35, wherein the central processing unit further comprises:
encode controller circuitry configured to determine a plurality of third encoding costs for the second candidate intra-prediction modes and select an encoding intra-prediction mode for the coding unit based at least in part on the third encoding costs; and
entropy encoder circuitry configured to encode the video frame based at least in part on the encoding intra-prediction mode to generate an encoded bitstream.

42. At least one machine readable medium comprising a plurality of instructions that, in response to being executed on a computing device, cause the computing device to provide video encoding by:
determining, for a coding unit of a video frame, an encoding cost for each of only a subset of a plurality of available intra-prediction angular modes to provide a plurality of first encoding costs associated with the subset of intra-prediction angular modes;
selecting a plurality of first candidate intra-prediction modes based at least in part on the plurality of encoding costs, wherein the first candidate intra-prediction modes includes at least a first intra-prediction angular mode from the subset of intra-prediction angular modes;
determining at least a second encoding cost for a second intra-prediction angular mode neighboring the first intra-prediction angular mode; and
providing a plurality of second candidate intra-prediction modes including at least one of the first intra-prediction angular mode or the second intra-prediction angular mode.

43. The machine readable medium of claim 42, wherein the subset of intra-prediction angular modes comprise at least one of every second, every third, or every fourth intra-prediction angular mode of the available intra-prediction angular modes.

44. The machine readable medium of claim 42, wherein determining at least the second encoding cost for the second intra-prediction angular mode neighboring the first intra-prediction angular mode further comprises determining a third encoding cost for a third intra-prediction angular mode neighboring the first intra-prediction angular mode, wherein the second and third intra-prediction angular modes are both immediate neighbors of the first intra-prediction angular mode.

45. The machine readable medium of claim 42 further comprising instructions that, in response to being executed on the computing device, cause the computing device to provide video encoding by:
determining, for the coding unit, a third encoding cost for an intra-prediction planar mode and a fourth encoding cost for an intra-prediction DC mode, wherein the candidate intra-prediction modes comprise at least one of the intra-prediction planar mode or the intra-prediction DC mode.

46. The machine readable medium of claim 42 further comprising instructions that, in response to being executed on the computing device, cause the computing device to provide video encoding by:
determining a plurality of third encoding costs for the second candidate intra-prediction modes, wherein the first encoding costs comprise a comparison of video frame pixels of the coding unit to video frame pixels of reference coding units associated with the subset of intra-prediction angular modes, and wherein the third encoding costs comprise more accurate encoding costs than the first encoding costs.

47. The machine readable medium of claim 42, wherein the first encoding costs comprise a comparison of original video frame pixels of the coding unit to predicted pixels of the coding unit for each of the subset of intra-prediction angular modes.

48. The machine readable medium of claim 42, wherein the subset of intra-prediction angular modes comprise every other intra-prediction angular mode of the available intra-prediction angular modes, wherein determining at least the second encoding cost for the second intra-prediction angular mode neighboring the first intra-prediction angular mode further comprises determining a third encoding cost for a third intra-prediction angular mode, and wherein the second and third intra-prediction angular modes are both immediate neighbors of the first intra-prediction angular mode.

49. The machine readable medium of claim 42, further comprising instructions that, in response to being executed on the computing device, cause the computing device to provide video encoding by:
determining a plurality of third encoding costs for the second candidate intra-prediction modes;
selecting an encoding intra-prediction mode for the coding unit based at least in part on the third encoding costs; and
encoding the video frame based at least in part on the encoding intra-prediction mode to generate High Efficiency Video Coding (HEVC) compliant bitstream.
